(19) United States
(12) Patent Application Publication
(10) Pub. No.: US 2019/0101998 A1
(43) Pub. Date: Apr. 4, 2019

(54) IN-CELL TOUCH ARRAY SUBSTRATE, DRIVING METHOD THEREOF, AND DISPLAY DEVICE

(71) Applicant: BOE TECHNOLOGY GROUP CO., LTD., Beijing (CN)

(72) Inventors: Min PENG, Beijing (CN); Hong WANG, Beijing (CN); Yaoqiu JING, Beijing (CN)

(73) Assignee: BOE TECHNOLOGY GROUP CO., LTD., Beijing (CN)

(21) Appl. No.: 15/543,900

(22) PCT Filed: Jan. 10, 2017
(86) PCT No.: PCT/CN2017/070739

§ 371 Date: Jul. 14, 2017

(30) Foreign Application Priority Data
Apr. 19, 2016 (CN) 201610245220.X

(51) Int. Cl. G06F 3/044; G06F 3/041; G02F 1/1333; G02F 1/1362; G02F 1/1343

(52) U.S. Cl. CPC G06F 3/044; G06F 3/0412; G02F 1/134309; G02F 1/136286; G02F 1/13338

(57) ABSTRACT

An in-cell touch array substrate, a driving method thereof, and a display device are provided. The in-cell touch array substrate includes a common electrode layer. The common electrode layer includes: pixel-related common electrodes corresponding to all pixel regions of the in-cell touch array substrate and configured to, at a touch stage, receive a common electrode signal; and shielding common electrodes corresponding to at least a part of a non-pixel region outside all the pixel regions and configured to, at the touch stage, receive a touch sensing signal.

### CROSS-REFERENCE TO RELATED APPLICATION

The present application claims a priority of the Chinese patent application No. 201610245220.X filed on Apr. 19, 2016, which is incorporated herein by reference in its entirety.

### TECHNICAL FIELD

The present disclosure relates to the field of display technology, in particular to an in-cell touch array substrate, a driving method thereof, and a display device.

### BACKGROUND

Currently, touch panels of most touch devices are arranged independent of liquid crystal display panels. The touch panel is arranged above the corresponding liquid crystal display panel, and there is a space between the liquid crystal display panel and the touch panel. External light beams may be reflected by an upper surface of the liquid crystal display panel and a lower surface of the touch panel, so a display effect of the liquid crystal display panel may be adversely affected in a bright environment such as an outdoor environment. In the case that the touch panel is capable of being used for display, it is able to form the liquid crystal display panel and the touch panel in one piece, and reduce a thickness and a weight of the entire display panel.

To meet this requirement, an in-cell touch technology has emerged and developed quickly. However, for the in-cell touch technology, usually a common electrode (VCOM) is divided in a simple manner. In addition, a direct current (DC) voltage is applied to the VCOM at a display stage, and an alternating current (AC) voltage is applied to the VCOM at a touch stage. During the switch between the display stage and the touch stage, a voltage jump may inevitably occur for the VCOM, resulting in degraded display quality of the liquid crystal display panel.

### SUMMARY

A main object of the present disclosure is to provide a scheme so as to prevent the occurrence of the voltage jump for the common electrode due to the DC voltage and AC voltage applied to the common electrode at the display stage and the touch stage respectively, thereby to improve the display quality of the liquid crystal display panel.

In one aspect, the present disclosure provides in some embodiments an in-cell touch array substrate, including a common electrode layer. The common electrode layer includes: pixel-related common electrodes corresponding to all pixel regions of the in-cell touch array substrate and configured to, at a touch stage, receive a common electrode signal; and shielding common electrodes corresponding to at least a part of a non-pixel region outside all the pixel regions and configured to, at the touch stage, receive a touch sensing signal.

Optionally, the pixel-related common electrode includes a plurality of pixel-related common sub-electrodes each corresponding to a subpixel region of each pixel.

Optionally, at the touch stage, each shielding common electrode and a gate line of the in-cell touch array substrate serve as a touch sensing electrode and a touch driving electrode respectively to form a mutual-capacitive touch capacitor.

Optionally, an orthogonal projection of each shielding common electrode onto a gate line layer is perpendicular to and intersects the gate line.

Optionally, the shielding common electrodes include a plurality of shielding common sub-electrodes, and the pixel-related common sub-electrodes in at least one column are arranged between every two adjacent shielding common sub-electrodes.

Optionally, the in-cell touch array substrate further includes a data line layer which includes a plurality of data lines. The shielding common electrodes include a plurality of strip-like shielding common sub-electrodes extending in a direction identical to the data lines, and orthogonal projections of the shielding common sub-electrodes onto the data line layer are in a one-to-one correspondence to the data lines and overlap the data lines.

Optionally, at the touch stage, the shielding common sub-electrode and the data line of the in-cell touch array substrate serve as a touch sensing electrode and a touch driving electrode respectively to form a mutual-capacitive touch capacitor.

Optionally, an orthogonal projection of each shielding common electrode onto the data line layer is perpendicular to and intersects the data line.

Optionally, the shielding common electrodes include a plurality of shielding common sub-electrodes, and the pixel-related common sub-electrodes in at least one row are arranged between every two adjacent shielding common sub-electrodes.

Optionally, the in-cell touch array substrate further includes a gate line layer which includes a plurality of gate lines. The shielding common electrodes include a plurality of strip-like shielding common sub-electrodes extending in a direction identical to the gate lines, and orthogonal projections of the shielding common sub-electrodes onto the gate line layer are in a one-to-one correspondence to the gate lines and overlap the gate lines.

Optionally, at the touch stage, the shielding common electrodes individually form a self-capacitive touch capacitor.

Optionally, the shielding common electrodes include a plurality of shielding common sub-electrodes each having a hollow-square shape and enclosing at least one pixel-related common sub-electrode.

Optionally, the in-cell touch array substrate further includes a data line layer including a plurality of data lines and a gate line layer including a plurality of gate lines. The shielding common electrodes include a plurality of strip-like first shielding common sub-electrodes and a plurality of strip-like second shielding common sub-electrodes. The first shielding common sub-electrodes extend in a direction identical to the data lines, and orthogonal projections of the first shielding common sub-electrodes onto the data line layer are in a one-to-one correspondence to the data lines and overlap the data lines. The second shielding common sub-electrodes extend in a direction identical to the gate lines, and orthogonal projections of the second shielding common sub-electrodes onto the gate line layer are in a one-to-one correspondence to the gate lines and overlap the gate line.

Optionally, the first shielding common sub-electrodes are perpendicular to the second shielding common sub-electrodes.

Optionally, the pixel-related common electrodes and the shielding common electrodes are separated from each other.

Optionally, the pixel-related common electrodes and the shielding common electrodes are configured to receive a common electrode signal at a display stage.

Optionally, the common electrode signal is a direct current (DC) voltage, and the touch sensing signal is an alternating current (AC) voltage.

In another aspect, the present disclosure provides in some embodiments a display device including the above-mentioned in-cell touch array substrate.

In yet another aspect, the present disclosure provides in some embodiments a driving method for an in-cell touch array substrate. The in-cell touch array substrate includes a common electrode layer which includes a pixel-related common electrodes corresponding to all pixel regions of the in-cell touch array substrate and shielding common electrodes corresponding to at least a part of a non-pixel region outside all the pixel regions. The driving method includes: at a touch stage, applying a common electrode signal to the pixel-related common electrodes and applying a touch sensing signal to the shielding common electrodes.

Optionally, the driving method further includes: at a display stage, applying the common electrode signal to the pixel-related common electrodes and the shielding common electrodes.

Optionally, the common electrode signal is a DC voltage, and the touch sensing signal is an AC voltage.

According to the in-cell touch array substrate, the driving method thereof and the display device in the embodiments of the present disclosure, as compared with the related art, it is able to prevent the occurrence of a voltage jump for the common electrode due to the DC voltage and the AC voltage applied to the common electrode at the display stage and the touch stage respectively, thereby to improve the display quality of a liquid crystal display panel.

### BRIEF DESCRIPTION OF THE DRAWINGS

FIG. 1 is a schematic view showing a VCOM division mode in the related art;

FIG. 2 is a schematic view showing an in-cell touch driving mode in the related art;

FIG. 3A is a schematic view showing a division mode 1 of a common electrode layer in some embodiments of the present disclosure;

FIG. 3B is a schematic view showing a division mode 2 of the common electrode layer in some embodiments of the present disclosure;

FIG. 3C is a schematic view showing a division mode 3 of the common electrode layer in some embodiments of the present disclosure;

FIG. 3D is a schematic view showing a state where each touch electrode plate corresponds to a subpixel region after the division of the common electrode layer using the division mode 3 in FIG. 3C;

FIG. 4 is a schematic view showing an in-cell touch driving mode for the division mode 2 in FIG. 2B is used; and

FIG. 5 is a schematic view showing an in-cell touch driving mode for the division mode 3 in FIGS. 3C and 3D is used.

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

As shown in FIG. 1 which is a schematic view showing a VCOM division mode in the related art, a VCOM 10 is divided into a plurality of regions 12 with an equal area, and these regions 12 may serve as touch electrodes at a touch stage. Each region 12 (i.e., the touch electrode) is connected to a Touch and Display Driver Integration (TDDI) via a lead.

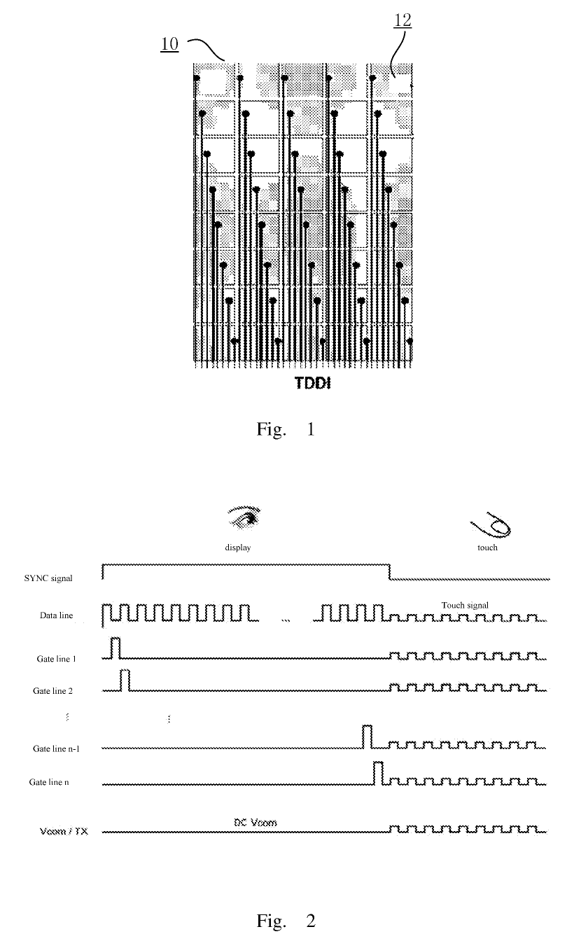

In this way, a DC voltage may be applied to the VCOM at a display stage, and an AC voltage may be applied to the VCOM at the touch stage, as shown in FIG. 2 which is a schematic view showing an in-cell touch driving mode in the related art. Due to this simple VCOM division mode, during the switch between the display stage and the touch stage, a voltage jump may easily occur for the VCOM, so the display quality of a liquid crystal display panel may be adversely affected.

In order to prevent the display quality of the liquid crystal display panel from being adversely affected by the voltage jump occurring for the VCOM, a method of processing a data signal that has been applied to a display integrated circuit (IC) and then applying the processed data signal to the liquid crystal display panel may be adopted in the related art. However, it is impossible for this method to fundamentally prevent the voltage jump for the VCOM, and the display quality may be improved very limitedly.

In this regard, the present disclosure provides in some embodiments an in-cell touch array substrate, so as to improve the display quality of the display panel. The in-cell touch array substrate may include a common electrode layer. The common electrode layer includes: pixel-related common electrodes corresponding to all pixel regions of the in-cell touch array substrate and configured to, at a touch stage, receive a common electrode signal; and shielding common electrodes corresponding to at least a part of a non-pixel region outside all the pixel regions and configured to, at the touch stage, receive a touch sensing signal.

In other words, a function of the common electrode as a touch sensing electrode for receiving the touch sensing signal may be separated from a function of the common electrode for receiving a common electrode signal. Through the division of the common electrode layer into two portions, the pixel-related common electrodes may merely be configured to receive the common electrode signal, and the shielding common electrodes may be configured to receive the touch sensing signal at the touch stage.

Based on the above-mentioned design, it is able to prevent the voltage jump for the VCOM (i.e., the touch electrode) acquired by the electrode division mode in the related art due to the switch between the DC voltage and the AC voltage at the display stage and the touch stage, thereby to prevent the display quality from being adversely affected.

Optionally, the pixel-related common electrodes may include a plurality of pixel-related common sub-electrodes each corresponding to one subpixel region of each pixel. Of course, in actual application, a plurality of subpixel regions may correspond to one pixel-related common sub-electrode. For example, for a pixel structure consisting of red (R), green (G) and blue (B) subpixels, each pixel-related common sub-electrode may correspond to one pixel region (three subpixel regions), three pixel regions (nine subpixel regions), or more pixel regions.

For an electrode plate where the common electrode serves as a touch capacity, a mutual-capacitive touch capacitor or a self-capacitive touch capacitor may be formed. Based on this, three modes will be described hereinafter.

Each shielding common electrode serves as the touch sensing electrode at the touch stage, so an electrode plate opposite thereto must be provided, so as to form the mutual-capacitive touch capacitor.

In mode (1), i.e., a mutual-capacitive touch mode, at the touch stage, each shielding common electrode and a gate line of the in-cell touch array substrate serve as a touch sensing electrode and a touch driving electrode respectively so as to form a mutual-capacitive touch capacitor.

In the case of forming the mutual-capacitive capacitor, the two electrode plates arranged opposite to each other need to at least partially overlap each other. For a touch operation, it is necessary to determine position information about a touch point corresponding to the touch operation on a touch panel. To facilitate the acquisition of the position information, the shielding common electrode may extend in a direction perpendicular to the gate line, i.e., an orthogonal projection of the shielding common electrode onto the gate line layer may be perpendicular to and intersect the gate line. Of course, in actual application, the shielding common electrode may be substantially perpendicular to the gate line, and at parts of the regions, it may extend in a direction angled relative to the gate line. In addition, optionally, the shielding common electrode may be arranged right above the data line, so as to determine coordination information about the touch point on the touch panel, thereby to implement the touch operation.

Further, the shielding common electrodes may include a plurality of shielding common sub-electrodes, and the pixel-related common sub-electrodes in at least one column may be arranged between every two adjacent shielding common sub-electrodes. The shielding common sub-electrode functions as to form the mutual-capacitive touch capacitor with the gate line so as to determine the position information about the touch point, so each shielding common sub-electrode extends in a direction identical to a column arrangement direction of the pixel-related common sub-electrodes, and identical to a direction in which the data line extends. In addition, each shielding common sub-electrode may correspond to the pixel-related common sub-electrodes arranged in one or more columns.

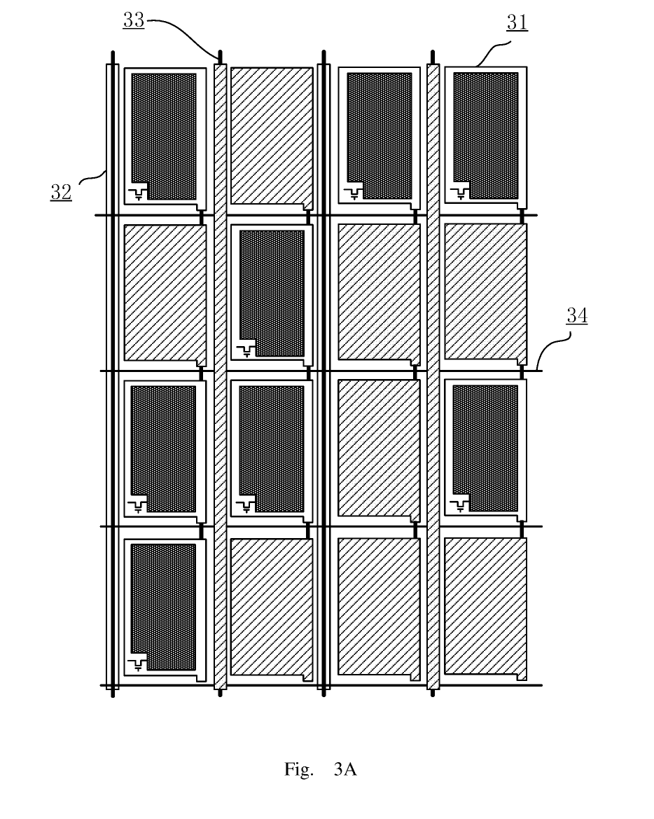

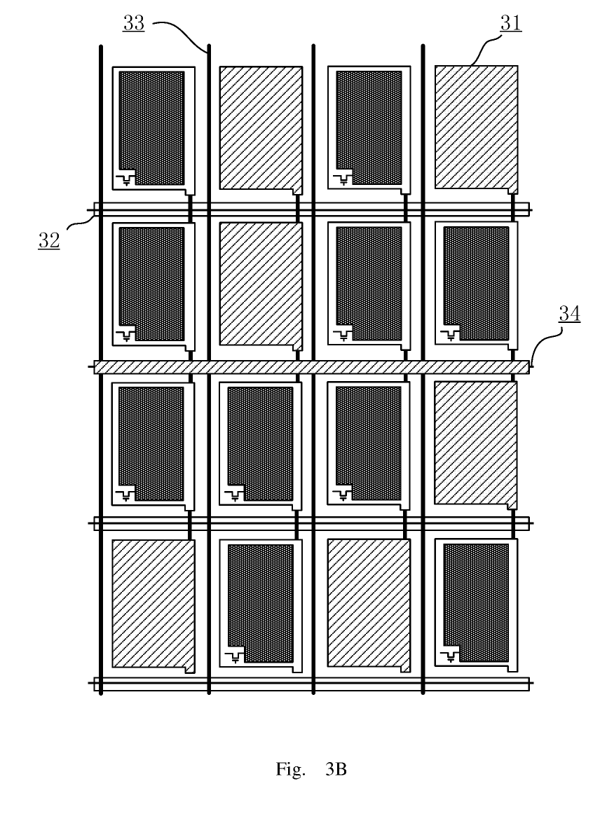

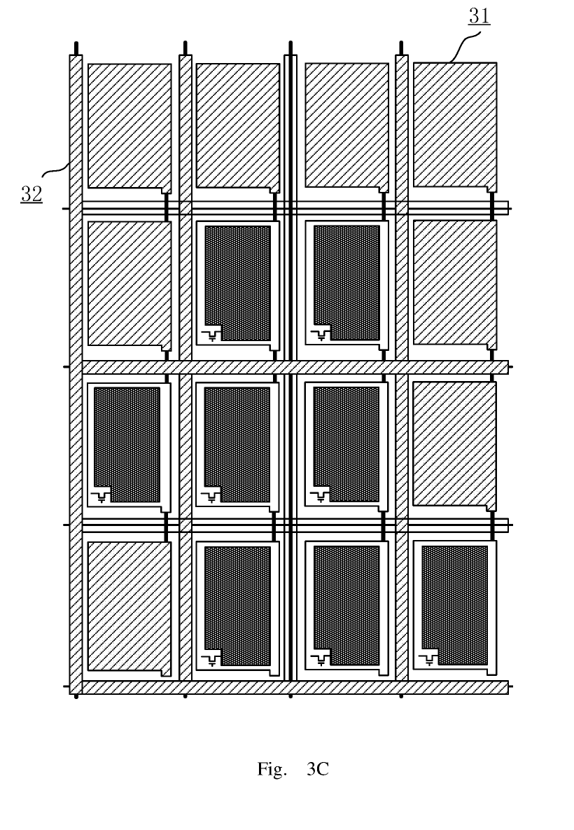

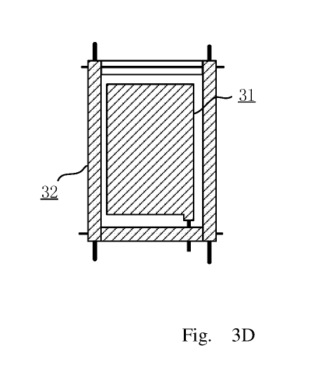

As shown in FIG. 3A which is a schematic view showing the division mode 1 of the common electrode layer, the common electrode layer is arranged on a pixel electrode layer, and each pixel-related common sub-electrode 31 corresponds to one subpixel display region. At each subpixel display region, the pixel-related common sub-electrode 31 is arranged above a corresponding pixel electrode, and the shielding common sub-electrode 32 is arranged right above the data line 33 and intersects the gate line 34 at a position where the mutual-capacitive touch capacitor is formed. In the case that a capacitance of the mutual-capacitive touch capacitor changes, it is indicated that a touch operation has been made just at the position where the mutual-capacitive touch capacitor is located. A horizontal coordinate of the touch point may be determined by calculating a position of the shielding common sub-electrode 32, and a longitudinal coordinate of the touch point may be determined by calculating a position of the gate line 34.

In mode (2), i.e., a mutual-capacitive touch mode, at the touch stage, each shielding common sub-electrode and the data line of the in-cell touch array substrate serve as a touch sensing electrode and a touch driving electrode respectively so as to form a mutual-capacitive touch capacitor.

As mentioned above, in the case of forming the mutual-capacitive capacitor, the two electrode plates arranged opposite to each other need to at least partially overlap each other, so the shielding common electrode also need partially overlap the data line. For the touch operation, it is necessary to determine the position information about the touch point corresponding to the touch operation on the touch panel. To facilitate the acquisition of the position information, the shielding common electrode may extend in a direction perpendicular to the data line, i.e., the orthogonal projection of the shielding common electrode onto the data line layer may be perpendicular to and intersect the data line. Of course, in actual application, the shielding common electrode may be substantially perpendicular to the data line, and at parts of the regions, it may extend in a direction angled relative to the data line. In addition, optionally, the shielding common electrode may be arranged right above the gate line, so as to determine the coordination information about the touch point on the touch panel, thereby to implement the touch operation.

Further, the shielding common electrodes may include a plurality of shielding common sub-electrodes, and the pixel-related common sub-electrodes in at least one row may be arranged between every two adjacent shielding common sub-electrodes. The shielding common sub-electrode functions as to form the mutual-capacitive touch capacitor with the data line so as to determine the position information about the touch point, so each shielding common sub-electrode extends in a direction identical to a row arrangement direction of the pixel-related common sub-electrodes, and identical to a direction in which the gate line extends. In addition, each shielding common sub-electrode may correspond to the pixel-related common sub-electrodes arranged in one or more rows.

As shown in FIG. 3B which is a schematic view showing the division mode 2 of the common electrode layer, the common electrode layer is arranged on the pixel electrode layer, and each pixel-related common sub-electrode 31 corresponds to one subpixel display region. At each subpixel display region, the pixel-related common sub-electrode 31 is arranged above a corresponding pixel electrode, and the shielding common sub-electrode 32 is arranged right above the gate line 34 and intersects the data line 33 at a position where the mutual-capacitive touch capacitor is formed. In the case that a capacitance of the mutual-capacitive touch capacitor changes, it is indicated that a touch operation has been made just at the position where the mutual-capacitive touch capacitor is located. A horizontal coordinate of the touch point may be determined by calculating a position of the data line 33, and a longitudinal coordinate of the touch point may be determined by calculating a position of the shielding common sub-electrode 32.

As compared with mode (1), mode (2) has more advantages. For example, the shielding common electrode and the data line forms the mutual-capacitive capacitor, and on and off states of a thin film transistor (TFT) may not be affected by a signal applied to the data line, so a display effect of the display panel may not be adversely affected. Hence, mode (2) may be selected in actual application.

In mode (3), i.e., a self-capacitive touch mode, at the touch stage, the shielding common electrodes may individually form a self-capacitive touch capacitor. In this case, the shielding common electrodes may include a plurality of shielding common sub-electrodes each having a hollow-square shape and enclosing at least one pixel-related common sub-electrode.

In mode (3), the unit touch electrode plate, i.e., a small common electrode (VCOM), in FIG. 1 is not a complete piece, and it may include the pixel-related common sub-electrodes each configured to merely receive the common electrode signal and the shielding common sub-electrodes each surrounding one or more pixel-related common sub-electrodes. As shown in FIG. 3C which is a schematic view showing the division mode 3 of the common electrode layer, sixteen subpixel regions as a whole serve as a display region corresponding to a unit touch electrode plate, i.e., the unit touch electrode plate 3 includes a plurality of pixel-related common sub-electrodes 31, and each shielding common sub-electrode 32 surrounds the corresponding pixel-related common sub-electrode 31. Of course, for the display region corresponding to the unit touch electrode plate, all the shielding common sub-electrodes 32 are connected to each other, and for the display regions corresponding to different unit touch electrode plates, the shielding common sub-electrodes 32 are separated from each other.

As shown in FIG. 3D which is a schematic view showing a state where each unit touch electrode plate corresponds to a subpixel region after the division of the common electrode layer using the division mode 3 in FIG. 3C, each unit touch electrode plate merely corresponds to one subpixel region, while in FIG. 3C, each unit touch electrode plate corresponds to a plurality of subpixel regions. In other words, FIG. 3D shows a special situation of FIG. 3C, i.e., one pixel-related common sub-electrode 31 is surrounded by one shielding common sub-electrode 32. In the state as shown in FIG. 3D, it is able to remarkably improve the touch sensitivity.

With respect to the electrode plate for the self-capacitive touch capacitor, it is unnecessary to provide an opposite electrode plate, so it is unnecessary to take the positional relationship between the electrode plate and the gate line layer or data line layer into consideration, and the entire structure is relatively simple.

It should be appreciated that, the electrode plate for the self-capacitive touch capacitor acquired through the division mode 3 in FIGS. 3C and 3D may also be used as an electrode plate for the mutual-capacitive touch capacitor, like the electrode plate acquired through the division mode 1 in FIG. 3A or the division mode 2 in FIG. 3B. For the electrode plate in FIGS. 3C and 3D, each shielding common sub-electrode 32 may also serve as a touch sensing electrode, and the gate line or data line may serve as a touch driving electrode, and at this time, the mutual-capacitive touch capacitor may be formed between the shielding common sub-electrode 32 and the gate line or data line.

In the embodiments of the present disclosure, the pixel-related common electrode and the shielding common electrode are each configured to receive the common electrode signal at the display stage, i.e., the shielding common electrode still services as the common electrode at the display stage, so as to ensure the display effect. Optionally, the common electrode signal may be a DC voltage, and the touch sensing signal may be an AC voltage.

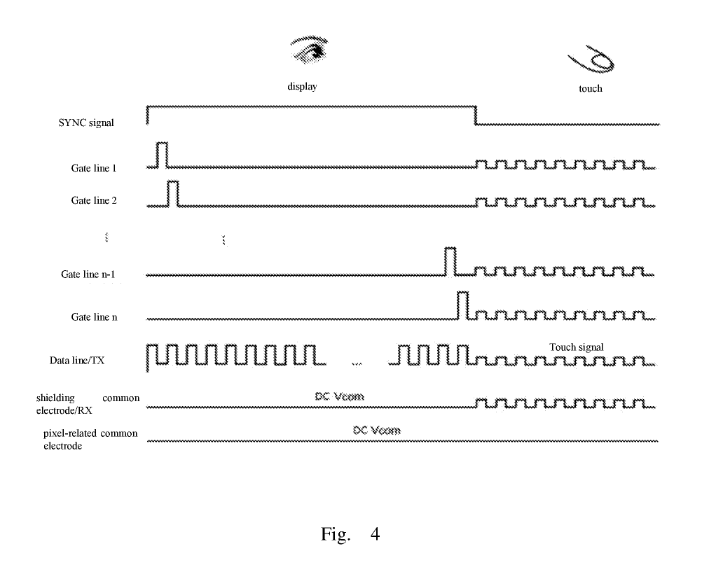

As shown in FIG. 4 which is a schematic view showing an in-cell touch driving mode for the division mode 2 in FIG. 3B, a sign “Shielding com” represents the shielding common electrode, and a sign “Pixel com” represents the pixel-related common electrode. At the display stage and the touch stage, the pixel-related common electrode is always configured to receive the common electrode signal in the form of the DC voltage, and at the touch stage, the shielding common electrode is configured to receive the touch sensing signal in the form of the AC voltage. As a result, it is able to prevent the occurrence of an unstable display effect due to the voltage jump, thereby to improve the display quality at the display stage.

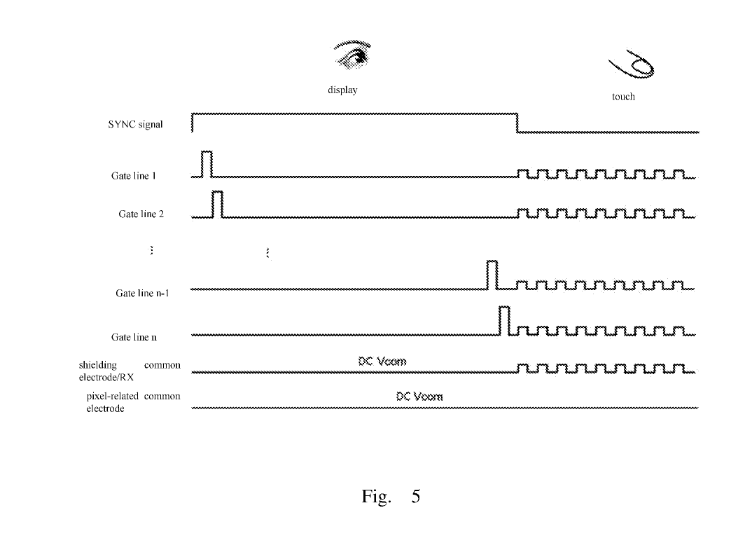

As shown in FIG. 5 which is a schematic view showing an in-cell touch driving mode for the division mode 3 in FIGS. 3C and 3D, at the display stage and the touch stage, the pixel-related common electrode is always configured to receive the common electrode signal in the form of the DC voltage, and at the touch stage, the shielding common electrode is configured to receive the touch sensing signal in the form of the AC voltage. Identically, through this driving mode, it is able to prevent the occurrence of the unstable display effect due to the voltage jump, thereby to improve the display quality at the display stage.

The present disclosure further provides in some embodiments a display device including the above-mentioned in-cell touch array substrate. The improvement on the display device lies in the improvement on the in-cell touch array substrate, thus the display device will not be particularly defined herein.

The present disclosure further provides in some embodiments a method for driving an in-cell touch array substrate. The in-cell touch array substrate includes a common electrode layer which includes a pixel-related common electrode corresponding to all pixel regions of the in-cell touch array substrate and a shielding common electrode corresponding to at least a part of a non-pixel region beyond all the pixel regions. The driving method includes a step of, at a touch stage, applying a common electrode signal to the pixel-related common electrode and applying a touch sensing signal to the shielding common electrode.

Optionally, the driving method further includes, at a display stage, applying the common electrode signal to the pixel-related common electrodes and the shielding common electrodes. In other words, the shielding common electrodes still serves as the common electrodes at the display stage, so it is able to ensure the stable display effect.

Optionally, the common electrode signal may be a DC voltage, and the touch sensing signal may be an AC voltage.

According to the embodiments of the present disclosure, the common electrode may be divided into the shielding common electrode and the pixel-related common electrode, and the shielding common electrode. The gate line or data line may serve as a sensing electrode (RX) and a driving electrode (TX) of an interactive capacitive electrode, or the shielding common electrode may form a self-capacitive electrode. As a result, during the switch between the touch stage and the display stage, it is able to maintain a storage capacitance for the liquid crystal panel, thereby to prevent the display quality from being adversely affected due to the voltage jump for the common electrode.

The above are merely the preferred embodiments of the present disclosure. Obviously, a person skilled in the art may make further modifications and improvements without departing from the spirit of the present disclosure, and these modifications and improvements shall also fall within the scope of the present disclosure.

1. An in-cell touch array substrate, comprising a common electrode layer, wherein the common electrode layer comprises: pixel-related common electrodes corresponding to all pixel regions of the in-cell touch array substrate and configured to receive a common electrode signal at a touch stage; and shielding common electrodes corresponding to at least a part of a non-pixel region outside all the pixel regions and configured to receive a touch sensing signal at the touch stage.

2. The in-cell touch array substrate according to claim 1, wherein the pixel-related common electrodes comprise a plurality of pixel-related common sub-electrodes each corresponding to a subpixel region of each pixel.

3. The in-cell touch array substrate according to claim 2, wherein each shielding common electrode and a gate line of the in-cell touch array substrate serve as a touch sensing electrode and a touch driving electrode respectively at the touch stage, to form a mutual-capacitive touch capacitor.

4. The in-cell touch array substrate according to claim 3, wherein an orthogonal projection of each shielding common electrode onto a gate line layer is perpendicular to and intersects the gate line.

5. The in-cell touch array substrate according to claim 4, wherein the shielding common electrodes comprise a plurality of shielding common sub-electrodes, and the pixel-related common sub-electrodes in at least one column are arranged between every two adjacent shielding common sub-electrodes.

6. The in-cell touch array substrate according to claim 4, further comprising a data line layer comprising a plurality of data lines, wherein the shielding common electrodes comprise a plurality of strip-like shielding common sub-electrodes extending in a direction identical to the data lines, and orthogonal projections of the shielding common sub-electrodes onto the data line layer are in a one-to-one correspondence to the data lines and overlap the data lines.

7. The in-cell touch array substrate according to claim 2, wherein each shielding common sub-electrode and a data line of the in-cell touch array substrate serve as a touch sensing electrode and a touch driving electrode respectively at the touch stage, to form a mutual-capacitive touch capacitor.

8. The in-cell touch array substrate according to claim 7, wherein an orthogonal projection of each shielding common electrode onto a data line layer is perpendicular to and intersects the data line.

9. The in-cell touch array substrate according to claim 8, wherein the shielding common electrodes comprise a plurality of shielding common sub-electrodes, and the pixel-related common sub-electrodes in at least one row are arranged between every two adjacent shielding common sub-electrodes.

10. The in-cell touch array substrate according to claim 8, further comprising a gate line layer comprising a plurality of gate lines, wherein the shielding common electrodes comprise a plurality of strip-like shielding common sub-electrodes extending in a direction identical to the gate lines, and orthogonal projections of the shielding common sub-electrodes onto the gate line layer are in a one-to-one correspondence to the gate lines and overlap the gate lines.

11. The in-cell touch array substrate according to claim 2, wherein the shielding common electrodes individually form a self-capacitive touch capacitor at the touch stage.

12. The in-cell touch array substrate according to claim 11, wherein the shielding common electrodes comprise a plurality of shielding common sub-electrodes each having a hollow-square shape and enclosing at least one pixel-related common sub-electrode.

13. The in-cell touch array substrate according to claim 11, further comprising a data line layer comprising a plurality of data lines and a gate line layer comprising a plurality of gate lines, wherein
the shielding common electrodes comprise a plurality of strip-like first shielding common sub-electrodes and a plurality of strip-like second shielding common sub-electrodes,
the first shielding common sub-electrodes extend in a direction identical to the data lines, and orthogonal projections of the first shielding common sub-electrodes onto the data line layer are in a one-to-one correspondence to the data lines and overlap the data lines, and
the second shielding common sub-electrodes extend in a direction identical to the gate lines, and orthogonal projections of the second shielding common sub-electrodes onto the gate line layer are in a one-to-one correspondence to the gate lines and overlap the gate line.

14. The in-cell touch array substrate according to claim 13, wherein the first shielding common sub-electrodes are perpendicular to the second shielding common sub-electrodes.

15. The in-cell touch array substrate according to claim 1, wherein the pixel-related common electrodes and the shielding common electrodes are separated from each other.

16. The in-cell touch array substrate according to claim 1, wherein the pixel-related common electrodes and the shielding common electrodes are configured to receive a common electrode signal at a display stage.

17. The in-cell touch array substrate according to claim 1, wherein the common electrode signal is a direct current (DC) voltage, and the touch sensing signal is an alternating current (AC) voltage.

18. A display device comprising the in-cell touch array substrate according to claim 1.

19. A method for driving an in-cell touch array substrate, wherein the in-cell touch array substrate comprises a common electrode layer comprising pixel-related common electrodes corresponding to all pixel regions of the in-cell touch array substrate and shielding common electrodes corresponding to at least a part of a non-pixel region outside all the pixel regions; and
the method comprises: at a touch stage, applying a common electrode signal to the pixel-related common electrodes and applying a touch sensing signal to the shielding common electrodes.

20. The method according to claim 19, further comprising: at a display stage, applying the common electrode signal to the pixel-related common electrodes, and the common electrode signal is a direct current (DC) voltage, and the touch sensing signal is an alternating current (AC) voltage.

21. (canceled)
